(19) United States
(12) Patent Application Publication
(10) Pub. No.: US 2006/0017743 A1
(43) Pub. Date: Jan. 26, 2006

(54) Display intensity filter

(76) Inventors: Victor Ga-Kui Chan, Richmond (CA); Raymond Chow, Richmond (CA)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 10/897,739

(22) Filed: Jul. 23, 2004

(51) Int. Cl. G09G 5/02

(52) U.S. Cl. 345/589

(57) ABSTRACT

Provided is a method and apparatus for adjusting intensity values of a frame of image data. Specifically, individual pixels of the frame of image data are processed by logic of a device to produce affected color values corresponding to the color values of the individual pixels. The affected color values are then transmitted to a display pipe leading to a display of the device. Further, the affected color values are not stored in a memory used to store the frame of image data. Thus, the frame of image data remains unmodified. The display pipe receives the affected color values and communicates the affected color values to the display for viewing. A temporary memory of the display that is independent of the memory used to store the frame of image data can accumulate the affected color values for viewing, if the affected color values are not immediately displayed.

### BACKGROUND

1. Field of the Invention

The present invention relates to image processing, and more specifically to affecting the intensity values of displayed image data without storing the affected intensity values.

2. Description of the Related Art

In a device such as a handheld computing device or mobile phone, the device can include a display controller to provide graphics processing between a host processor (host) and a display. Among many graphics processing functions, one function of the display controller is to adjust the display brightness, or intensity, of image and text displayed on a screen. Adjusting the display brightness permits the creation of visual effects such as highlighting or de-emphasizing the image and text, provide fade-in/fade-out effects, or flashing the display. However, adjusting the display brightness to provide a feature rich visual environment has a detrimental impact on the resources of the device.

Specifically, methods of adjusting the display brightness such as look up table (LUT) reprogramming, bit block transfer (BitBLT) operations, overlay window processing, and direct host processing of a display memory has a detrimental impact on the device by increasing host processing and power consumption. For example, LUT reprogramming can require considerable host processing by affecting the intensity of a portion of the display. Further, fade-in/fade-out effects and continuous brightening/dimming effects require increased bus traffic to and from the host.

Although BitBLT operations are not as host traffic intensive as LUT reprogramming, BitBLT operations do recursive host processing. Additionally, the BitBLT operations modify data stored in the display memory. Generally, modifications to the display memory detrimentally impact the device because any overwritten data must be rewritten when required for other processes. Further, when using overlay window processing to achieve a desired intensity effect, additional display memory and circuitry are added to the device. However, devices have limited capacity to add display memory and circuitry and thus, overlay window processing is not an effective solution. Direct host processing of the display memory to adjust the display brightness suffers from similar drawbacks to the previous solutions by increasing host processing, host traffic, and power consumption.

Accordingly, what is needed is a method and apparatus for adjusting the display intensity of image and text of a device, while avoiding detrimental impacts to the resources and operation of the device.

### SUMMARY

Broadly speaking, the present invention is a method and apparatus to adjust the intensity of image data. Specifically, adjusted intensity values produced by a display intensity filter of a controller are displayed as an intensity adjusted pixel without storage in a display memory. It should be appreciated that the present invention can be implemented in numerous ways, such as a process, an apparatus, or a device, of which several inventive embodiments of the present invention are described below.

In an embodiment of a method of adjusting an intensity value associated with an image displayed on a portable electronic device, the method includes receiving a pixel of image data stored in a display buffer and adjusting an intensity value of the pixel of image data while transmitting the pixel of image data from the display buffer to a display. The method also includes transmitting the intensity adjusted pixel to the display without overwriting the pixel of image data in the display buffer.

In an embodiment of a display controller for adjusting an intensity value associated with an image displayed on a portable electronic device, the display controller includes a register block for storing a value determining an intensity adjustment operation. Further, a display buffer is coupled to the register block, such that the display buffer is configured to store a pixel of image data. The pixel of image data remains unmodified in the display buffer during the adjusting of the intensity value. The display controller also includes an intensity filter module coupled to the register block and the display buffer. The intensity filter module has intensity filter logic, which is configured to modify the intensity value of the pixel of image data and transmit the modified value of the pixel of image data to a display pipe.

In an embodiment of a portable electronic device for adjusting an intensity value, the portable electronic device includes a processor capable of operating on a frame of image data. The frame of image data has a plurality of pixels and a display controller is in communication with the processor, such that the display controller further includes, a register block for storing a value to determine an intensity adjustment operation. The display controller also includes a display buffer coupled to the register block, such that the display buffer is configured to store a pixel of image data of the plurality of pixels. The pixel of image data remains unmodified in the display buffer during the adjusting of the intensity value. Further, an intensity filter module is coupled to the register block and the display buffer. The intensity filter module has intensity filter logic, which is configured to modify the intensity value of the pixel of image data and transmit the modified value of the pixel of image data to a display pipe. The portable electronic device also includes a display in communication with the display controller through the display pipe.

Other aspects of the invention will become apparent from the following detailed description, taken in conjunction with the accompanying drawings, illustrating by way of example the principles of the invention.

### BRIEF DESCRIPTION OF THE DRAWINGS

Exemplary embodiments of the invention may be understood by reference to the following description, taken in conjunction with the accompanying drawings in which:

FIG. 1 is a diagram illustrating a device for affecting the intensity values of an image, in accordance with an embodiment of the invention;

FIG. 2 is a diagram illustrating a register block containing data for affecting the intensity values of an image, in accordance with an embodiment of the invention;

FIG. 3 is a diagram illustrating an intensity filter module for affecting the intensity values of an image, in accordance with an embodiment of the invention;

FIG. 4A is a diagram illustrating a process of affecting the intensity values of an image, in accordance with an embodiment of the invention;

FIG. 4B is a diagram illustrating another process of affecting the intensity values of an image, in accordance with an embodiment of the invention;

FIG. 5A is a flowchart diagram illustrating a method of affecting the intensity values of an image, in accordance with an embodiment of the invention;

FIG. 5B is a flowchart diagram illustrating a method of calculating intensity values of an image, in accordance with an embodiment of the invention;

FIG. 5C is a flowchart diagram illustrating a method of calculating intensity values of an image using a shifting operation, in accordance with an embodiment of the invention; and

FIG. 5D is a flowchart diagram illustrating a method of calculating intensity values of an image using a masking operation, in accordance with an embodiment of the invention.

### DETAILED DESCRIPTION

The following embodiments describe a method and apparatus for adjusting the intensity, or display brightness, for a region of a display frame. A display frame contains data including image or text, referred to as a frame of image data. Further, the frame of image data is represented by pixels with a color scheme such as RGB or YUV. For simplicity, the following embodiments are described using an RGB color scheme. However, one of ordinary skill in the art can appreciate that any type of color scheme is possible, as long as a region of the display frame is adjusted for intensity.

Adjusting the intensity of the frame of image data permits a feature rich visual multimedia environment by providing several visual effects. For example, the visual effects include brightening/dimming, panning/scrolling, and scaling with brightening/dimming. An exemplary embodiment includes a method that adjusts intensity values of the pixels of the frame of image data. The intensity values are representations of the pixels as color values in binary, hexadecimal, or any other suitable counting/numbering system.

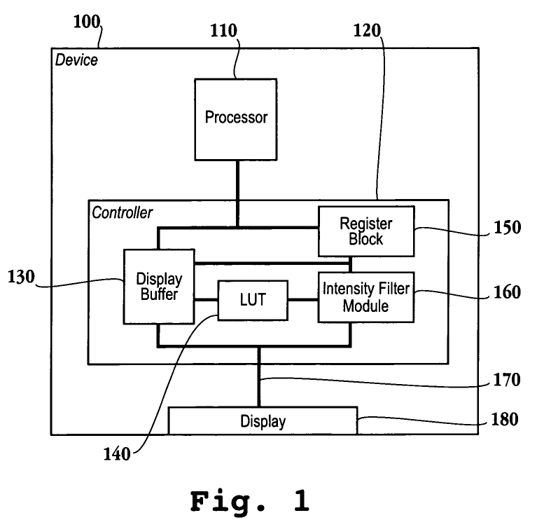

During the adjustment of the intensity values, color values of the pixels of the frame of image data are operated on to produce affected color values, or intensity adjusted pixels. These intensity adjusted pixels are then displayed on the fly. On the fly processing will be described in more detail in accompaniment to descriptions of the embodiments of FIGS. 1 through 5D. It will be obvious, however, to one skilled in the art, that the present invention may be practiced without some or all of these specific details. In other instances, well known process operations have not been described in detail in order not to unnecessarily obscure the present invention.

Various exemplary embodiments include the method and apparatus for adjusting intensity. For example, embodiments of an apparatus include mobile phones, handheld devices, such as Personal Digital Assistants (PDAs), digital and analog cameras that display frames of image data, and other devices that display frames of image data. However, the embodiments described herein may be used with any device for adjusting the intensity values of the frame of image data.

Accordingly, FIG. 1 is a diagram illustrating a device 100 for affecting the intensity values of an image, in accordance with an embodiment of the invention. The device 100 includes components such as a processor 110, a display controller 120 (controller) and a display 180 coupled to the controller 120 with a connector 170. The processor 110 is any type of host processor capable of manipulating instructions. One such instruction includes storing the frame of image data in a memory of the controller 120. The controller 120 is a graphics controller configured to adjust intensity values by generating affected color values. The affected color values are transmitted to the display 180 for viewing via the connector 170. Of course, one of ordinary skill in the art will recognize that the controller 120 is capable of performing many types of graphics processing in addition to adjusting intensity values.

The display 180 can be a Liquid Crystal Display (LCD) panel such as a Thin Film Transistor (TFT) display or a Random Access Memory (RAM) based panel. During a refresh of the TFT display, the adjusted intensity values are displayed. To produce a complete image on the display 180, the TFT display can include a temporary memory to store the adjusted intensity values. Without using the temporary memory, the TFT display requires a particular timing because the refresh may only have a partial image to display. To remove timing considerations, the temporary memory can store adjusted intensity values to be retrieved by the TFT display during the refresh. Further, the RAM-based panel includes a display memory for temporary storage of the adjusted intensity values because RAM-based panels do not require a refresh and therefore do not have this timing restriction. In other exemplary embodiments, other types of displays 180 are possible, as long as the displays 180 can show adjusted intensity values.

The connector 170 is part of a display pipe of the device 100. Specifically, the connector 170, connectors within the controller 120, and connectors of the display 180 comprise the totality of the display pipe. By transmitting affected color values on the display pipe without storing the affected color values in a memory of the controller 120, the adjustment of the intensity values and the result shown in the display 180 is processing on the fly. It should be appreciated that processing on the fly avoids overwriting image data stored in the memory of the controller 120. Thus, the frame of image data stored in the memory of the controller 120 is unmodified during processing on the fly.

The controller 120 includes a display buffer 130, a look up table (LUT) 140, a register block 150, and an intensity filter module 160. Although illustrated having connections as shown in FIG. 1, these modules of the controller 120 can communicate with one another via a common communication bus (not shown). The display buffer 130 is a memory region within the controller 120 that stores frames of image data. The frames of image data are stored in the display buffer 130 after the device 100 receives or generates the frames of image data. For example, a camera (not shown) of the device 100 can capture frames of image data. Further, the device 100 can have wireless capability such as Bluetooth, Wi-Fi, or cellular to receive frames of image data. It can be appreciated by one of ordinary skill in the art that the frames of image data stored in the display buffer 130 can arrive from any source, wireless or wired, as long as the frames of image data are processed by the controller 120 to adjust intensity values. After storage in the display buffer 130, the frames of image data are processed to produce intensity adjusted pixels.

The frame of image data stored in the display buffer 130 is transmitted to the LUT 140, in order to extract pixels from the frame of image data. Consequently, the LUT 140 receives an exemplary pixel represented by an RGB888 color format, where each pixel includes 8 bits to represent each color component of the RGB color scheme. Thus, 24 bits representing the red (R), green (G), and blue (B) color components define the color values affected to adjust the intensity of the image data. It should be appreciated that more or less bits can represent each color component, as the use of 8 bits per color component is exemplary and not meant to be limiting.

The pixel is mapped within the LUT 140 to produce an appropriate color on the display 140. However, before transmitting the color to the display, the LUT 140 transmits the color values of the pixel to the intensity filter module 160. The intensity filter module 160, in conjunction with data stored in the register block 150 can perform operations to affect the color values, which become adjusted intensity values.

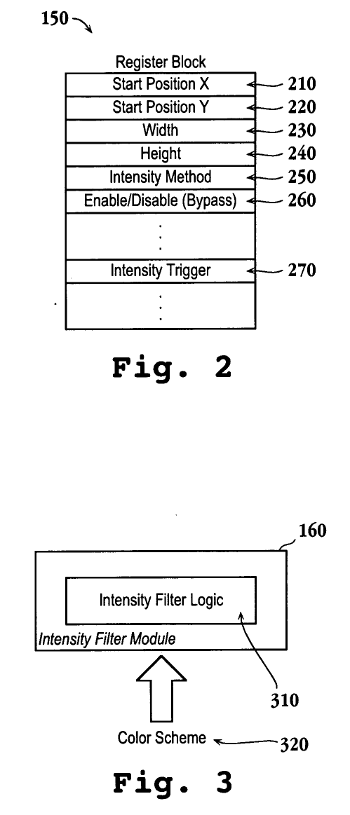

FIG. 2 is a diagram illustrating the register block 150 containing data for affecting the intensity values of an image, in accordance with an embodiment of the invention. The register block 150 is capable of storing data such as a start position-x 210, a start position-y 220, a width 230, a height 240, an intensity method 250, an enable/disable value (bypass) 260, and an intensity trigger value 270 within registers.

The start position-x 210 and the start position-y 220 are the (x,y) components of row (x) and column (y) positions of the first pixel of the frame of image data to be affected. Thus, the start position-x 210 and the start position-y 220 define a start position corresponding to the entire frame of image data or a portion of the frame of image data. The width 230 and the height 240 define the size of the frame of image data. For example, if the width 230 is equal to five pixels and the height 240 is equal to eight pixels, then the rectangular frame of image data has an area of 40 pixels (i.e. 5×8=40).

Further, if the start position-x 210 has a value of 20 and the start position-y 220 has a value of 10, then a raster scan of the frame of image data moves five pixels from 20 to 25 along the width 230 of the frame of image data and moves eight pixels from 10 to 18 along the height 240 of the frame of image data. During the raster scan, horizontal and vertical frame counters (not shown) keep track of the pixel count. It should be appreciated that the invention is not limited to rectangular frames of image data, as other non-rectangular shapes may be utilized, as long as the area of the non-rectangular shape is captured by the data stored in the register block 150 (FIG. 1).

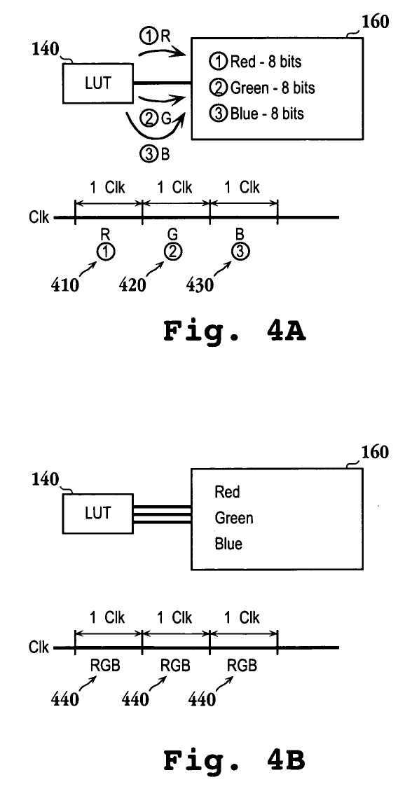

The intensity method 250 is a value that defines the type of operation to be performed on a pixel to produce affected color values. For example, if the intensity method 250 includes a value for a shifting operation, then the pixel will be shifted by an amount equivalent to the value to produce the affected color value. However, if the intensity method 250 includes a masking value for a masking operation, then the pixels are logically combined with the masking value to produce the affected color value. Specific examples of the shifting and masking operations will follow in relation to FIGS. 3 through 4B.

The bypass value 260 determines whether the pixel bypasses the intensity filter module 160. Specifically, if the bypass value 260 is set to a disabled state, then the pixel is transmitted to the intensity filter module 160 from the LUT 140. If the bypass value 260 is set to an enabled state, then the pixel is transmitted directly to the display pipe, thereby bypassing the intensity filter module 160. The intensity trigger value 270 can also initiate the adjustment of intensity values. Specifically, the intensity trigger value 270 can be set to an off-state. During the off-state, no intensity values are adjusted. Alternatively, when the intensity trigger value 270 is set to an on-state, the intensity values are adjusted to a completion-state. In contrast to the bypass value 260, the intensity trigger value 270 starts and adjusts intensity values until completion. The bypass value 260 permits the adjustment of intensity values until the bypass is enabled, i.e. the bypass value 260 may be enabled during the adjustment of the intensity values, while the trigger value 270 may not be turned on or off during the adjustment of the intensity values.

FIG. 3 is a diagram illustrating the intensity filter module 160 for affecting the intensity values of an image, in accordance with an embodiment of the invention. Here, a pixel having a color scheme 320 enters the intensity filter module 160. Within the intensity filter module 160, the intensity filter logic 310 performs operations to adjust intensity values. Specifically, the intensity filter logic 310 includes circuitry to perform shifting operations using shifting logic and masking operations using masking logic.

FIG. 4A is a diagram illustrating a process of affecting the intensity values of an image, in accordance with an embodiment of the invention. The LUT 140 transmits a color value of a pixel to the intensity filter logic 160 for processing. For example, during one clock cycle, the LUT 140 transmits a red color value 410 to the intensity filter module 160. Consequently, in two other clock cycles, a green color value 420 and a blue color value 430 are independently transmitted to the intensity filter module 160.

The red color value 410 can be a binary value such as “00110101.” Upon receiving the red color value 410, the intensity filter logic 310 determines whether to perform a shifting operation or a masking operation to adjust the intensity value of the red color value 410 according to the register value discussed above with reference to FIG. 2. For example, the intensity method 250 can indicate that the red color value 410 should be brightened using a shifting operation. Brightening is equivalent to increasing the intensity value of the red color value 410. To brighten the red color value 410 using the shifting operation, the intensity method 250 indicates to the intensity filter module 310 to left shift by two bits. Accordingly, the affected color value transmitted to the display pipe is “11010100.”

In the special case of a shifting operation that loses a “1” during a shift, the intensity filter logic 310 transmits the maximum or minimum intensity value to the display pipe. For example, if the red color value 410 is “00110101” and the intensity method 250 indicate brightening using a 3-bit left shift operation, then “001” is left shifted off the red color value 410. Thus, the intensity filter logic 310 transmits “11111111” to the display pipe, indicating the maximum intensity value. Alternatively, to dim, or decrease the intensity value of the red color value 410, the intensity method 250 indicates a right shift operation. If all “1s” are shifted off the red color values 410, then the intensity value is fixed to “00000000,” thus showing nothing on the display.

However, if the intensity method 250 includes a masking value for a masking operation, then the intensity filter logic 310 performs a masking operation. For example, the intensity method 250 can indicate that the red color value 410 represented by “00110101” should be brightened by performing a logical operation. Accordingly, an AND operation operates on the masking value “00000111” and the red color value 410 to produce “00000101,” which is then transmitted to the display pipe. Other masking operations include logical operations such as OR, XOR, NOT, among other logical operations. One of ordinary skill in the art will recognize that any logical operation is possible during the masking operation, as long as the color values are affected to modify the brightness.

The masking value of the intensity method 250 can be obtained from a register outside the register block 150. For example, any suitable register is capable of storing the masking value, such as a register of the processor 110. Thus, one of ordinary skill in the art will recognize that the masking value can be obtained from any source, as long as the embodiments of the present invention described herein can identify a location for obtaining the masking value for adjusting an intensity value.

The intensity filter logic 310 also performs operations on non-binary color values. For example, if the red color value 410 is represented in hexadecimal by “1F,” then the masking operation using a masking value of all “F” produces the maximum intensity value. Further, the masking value can be used to mask out the color value using a masking value of all zeros. In addition to shifting and masking operations, any arithmetic-type operation is possible. For example, multiplication and addition are exemplary operations used by the intensity filter logic 310 to produce affected color values. Thus, multiple intensity adjustment operations, such as the shifting operation and the masking operation, produce intensity adjusted pixels. The intensity filter logic 310 can include logic for any combination of intensity adjustment operations, as long as the controller 120 has the capacity to have additional circuitry.

By adjusting intensity values, the intensity filter logic 310 can also perform fade-in/fade-out operations for all or part of the display 180. The intensity filter logic 310 can include a delay counter (not shown) to specify the duration of the fading operation and a start and end fade setting (not shown). Correspondingly, the intensity trigger value 270 can initiate the fading operation. Thus, masking out all the color values of a pixel for a region of the frame of image data is equivalent to a fade-out operation. After the intensity filter logic 310 performs the shifting or masking operation to produce an affected red color value, the intensity filter logic 310 continues to operate on subsequent color values transmitted by the LUT 140.

FIG. 4B is a diagram illustrating another process of affecting the intensity values of an image, in accordance with an embodiment of the invention. Specifically, the intensity filter module 160 can receive all the color values of an RGB pixel 440 during one clock cycle. Thus, the red color value 410, the green color value 420, and the blue color value 430 are operated on simultaneously by the intensity filter logic 310 to produce three affected color values. Alternatively, operations on a combination of the color values are possible. For example, the intensity filter logic 310 may operate on the red color value 410 and the blue color value 430 without affecting the green color value 420. Thus, any operations on a combination of color values are possible, as long as the intensity filter logic 310 adjusts intensity values.

The operations performed by the exemplary apparatus of FIGS. 1 to 4B are illustrated following a particular sequence. However, the operations can be performed in parallel with other operations. For example, a pipelined architecture permits the operations to be performed in parallel to maximize device 100 resource utilization.

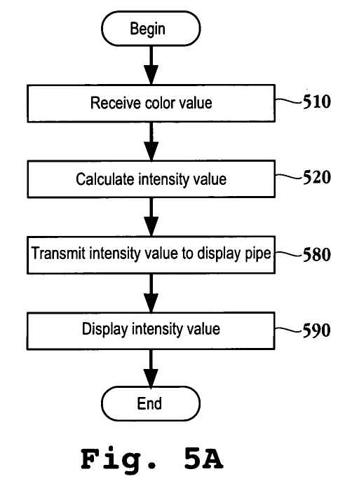

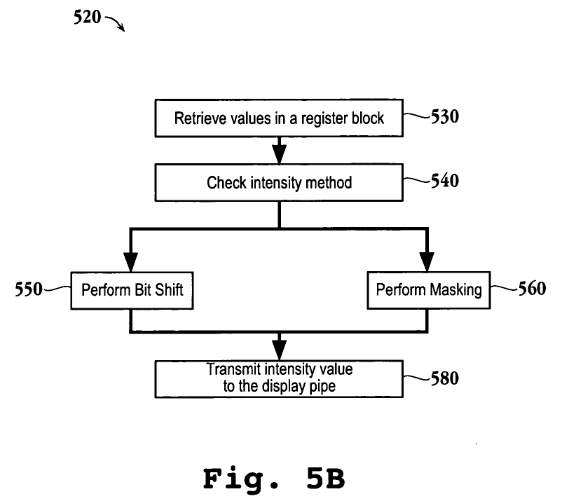

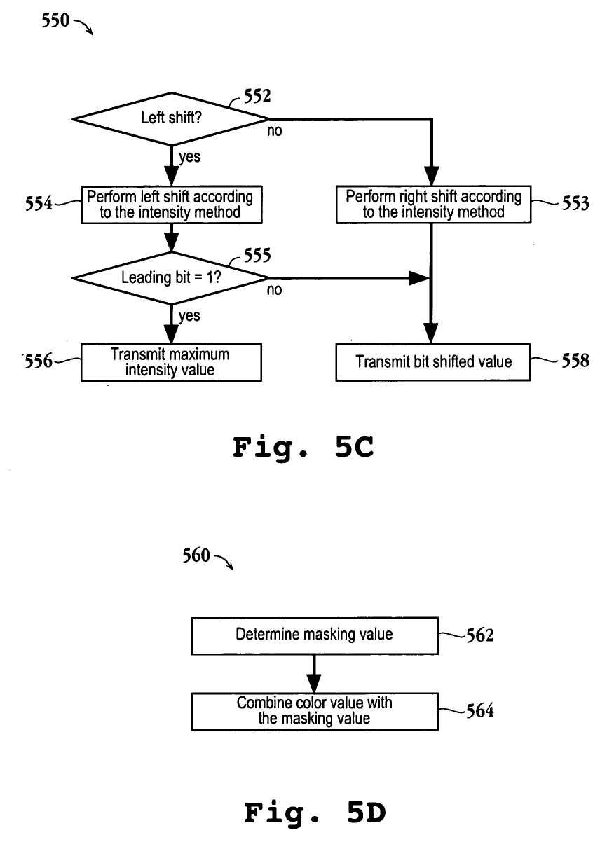

FIG. 5A is a flowchart diagram illustrating a method of affecting the intensity values of an image, in accordance with an embodiment of the invention. In operation 510, the intensity filter module receives color values. As previously described, the color values can be operated on individually or simultaneously by logic in the intensity filter logic. Of course, operations on a combination of color values are possible, such as RG without B, during one clock cycle. In order to produce affected color values, the intensity filter logic calculates intensity values in operation 520. Specifically, the calculation uses the position information and other values stored in the register block to produce affected color values. Thus, the intensity filter logic includes logic to position a pixel in a frame of image data using the start position-x, the start position-y, the width, and the height mentioned above with reference to FIG. 2. After calculating the intensity value, the intensity filter module transmits the intensity value to the display pipe in operation 580. To transmit the intensity value, which is the affected color value, the intensity filter logic includes logic to communicate the affected color value to the display pipe. It should be appreciated that the affected color value is not stored in the display buffer of the controller of FIG. 1. Thus, the original image data remains intact in the display buffer. Thereafter, in operation 590, a panel displays the intensity value for viewing.

FIG. 5B is a flowchart diagram illustrating a method of calculating intensity values of an image of operation 520, in accordance with an embodiment of the invention. In operation 530, the intensity filter logic retrieves values stored in the register block of FIG. 1. The position information is used to determine the region of a frame of image data to affect as described above. Then, in operation 540, the intensity filter module checks the intensity method by checking a register value associated with the intensity method as discussed with reference to FIG. 2. If the intensity method indicates a shifting operation, then the method proceeds to operation 550. Otherwise, if the intensity method indicates a masking operation, then the method proceeds to operation 560. It should be appreciated that the intensity method can indicate any suitable type of arithmetic operation to adjust intensity values and is not limited to a shifting or masking operation. In operation 550, the intensity filter logic performs a bit shift. In operation 560, the intensity filter logic performs masking. Thus, after adjusting the intensity value, the intensity filter module transmits the intensity value to the display pipe.

FIG. 5C is a flowchart diagram illustrating a method of calculating intensity values of an image using a shifting operation of operation 550, in accordance with an embodiment of the invention. If the intensity method indicates a left shift in operation 552, then the intensity filter logic performs the left shift in operation 554. In decision operation 555, if the leading bit is a “1”, then the intensity filter logic transmits the maximum intensity value to the display pipe in operation 554. Otherwise, the intensity filter logic transmits the bit-shifted value to the display pipe.

Alternatively, if the intensity method indicates not performing a left shift, then the intensity filter logic performs a right shift in operation 553. Then, in operation 558, the intensity filter logic transmits the bit-shifted value to the display pipe. In another embodiment (not shown) the intensity filter logic transmits the minimum intensity value when the trailing bit of “1” is right shifted off. Thus, the method of FIG. 5C illustrates that embodiments can differ by the boundary conditions checked. It will be appreciated by those of ordinary skill in the art that many special cases, such as checking boundary conditions for leading or trailing “1s” is possible, as long as the intensity filter logic adjusts intensity values.

FIG. 5D is a flowchart diagram illustrating a method of calculating intensity values of an image using a masking operation of operation 560, in accordance with an embodiment of the invention. Specifically, in operation 562, the intensity filter logic determines the masking value indicated by a register value corresponding to the intensity method. Then, in operation 564, the intensity filter logic combines the color value with the masking value to produce the affected color value. As previously described, pixels represented by the color values of a color scheme can be further represented as binary, hexadecimal, decimal, or any other suitable numerical system of computing systems.

Embodiments of the present invention may be practiced with various computer system configurations including hand-held devices, microprocessor systems, microprocessor-based or programmable consumer electronics, minicomputers, mainframe computers and the like. The invention can also be practiced in distributed computing environments where tasks are performed by remote processing devices that are linked through a wire-based or wireless network.

With the above embodiments in mind, it should be understood that the invention can employ various computer-implemented operations involving data stored in computer systems. These operations are those requiring physical manipulation of physical quantities. Usually, though not necessarily, these quantities take the form of electrical or magnetic signals capable of being stored, transferred, combined, compared and otherwise manipulated.

Any of the operations described herein that form part of the invention are useful machine operations. The invention also relates to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data, which can be thereafter read by a computer system. The computer readable medium also includes an electromagnetic carrier wave in which the computer code is embodied. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion.

Although the foregoing invention has been described in some detail for purposes of clarity of understanding, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the appended claims.

1. A method of adjusting an intensity value associated with an image displayed on a portable electronic device, comprising:
receiving a bit sequence representing a pixel of image data stored in a display buffer;
determining an intensity adjustment operation type according to a first stored bit value;
adjusting an intensity value of the pixel of image data according to the intensity adjustment operation type while transmitting the pixel of image data from the display buffer to a display; and
transmitting the intensity adjusted pixel to the display without overwriting the pixel of image data in the display buffer.

2. The method of claim 1, wherein adjusting the intensity value of the pixel further includes determining whether to proceed with the intensity adjustment operation type according to a second stored bit value.

3. The method of claim 1, wherein adjusting the intensity value of the pixel further includes setting a third bit value requiring completion of the intensity adjustment operation type.

4. The method of claim 1, wherein the transmitting further includes temporarily storing the intensity adjusted pixel in a memory region incorporated into the display.

5. The method of claim 1, wherein the adjusting further includes performing one of a shifting operation or a masking operation.

6. The method of claim 5, wherein the shifting operation further includes shifting bits of the bit sequence representing the pixel.

7. The method of claim 5, wherein the masking operation further includes combining a masking value with the bit sequence.

8. The method of claim 5, wherein the masking operation further includes combining a masking value and the bit sequence through an AND operation.

9. The method of claim 1, wherein adjusting the intensity value of the pixel is performed independent of adjacent pixel values to the pixel.

10. A display controller for adjusting an intensity value associated with an image displayed on a portable electronic device, comprising:
a register block storing a first, second, and third bit value, the first bit value determining an intensity adjustment operation type, the second bit value enabling execution of the intensity adjustment operation type, the third bit value determining whether the intensity adjustment operation type may be interrupted;
a display buffer coupled to the register block, wherein the display buffer is configured to store a bit sequence representing a pixel of image data, the bit sequence representing the pixel of image data remaining unmodified in the display buffer during the adjusting of the intensity value; and
an intensity filter module coupled to the register block and the display buffer, the intensity filter module having intensity filter logic, configured to modify the intensity value of the pixel of image data and transmit the modified value of the pixel of image data to a display pipe.

11. The display controller of claim 10, further including:
a look up table coupled to the display buffer, the look up table being configured to identify a color value of the pixel of image data.

12. The display controller of claim 10, wherein the intensity filter logic includes a horizontal and vertical frame counter configured to track a pixel position being displayed.

13. The display controller of claim 10, further comprising:
a display panel having a memory region integrated therein.

14. The display controller of claim 10, wherein the intensity filter logic is configured to modify the intensity value of the pixel of image data independent of any neighboring pixel values.

15. The display controller of claim 10, wherein the display controller is integrated into a cellular telephone.

16. The display controller of claim 10, wherein the intensity filter logic is configured to shift the bit sequence representing the pixel in order to modify the intensity value.

17. A portable electronic device for adjusting an intensity value, comprising:
a processor capable of executing commands having a frame of image data stored;
a display controller in communication with the processor, wherein the display controller includes,
a register block storing a first second and third bit value, the first bit value determining an intensity adjustment operation type, the second bit value enabling execution of the intensity adjustment operation type the third bit value determining whether the intensity adjustment operation type may be interrupted,
a display buffer coupled to the register block, wherein the display buffer is configured to receive a bit sequence representing a pixel of image data of the frame of image data from the processor, the pixel of image data remaining unmodified in the display buffer during the adjusting of the intensity value, and
an intensity filter module coupled to the register block and the display buffer, the intensity filter module having intensity filter logic configured to modify the intensity value of the pixel of image data independent of neighboring pixel data and transmit the modified value of the pixel of image data to a display pipe; and
a display in communication with the display controller through the display pipe.

18. The portable electronic device of claim 17, further comprising:
a look up table coupled to the display buffer, the look up table being configured to identify a color value of the pixel of image data.

19. The portable electronic device of claim 17, wherein the intensity filter logic includes a horizontal and vertical frame counter configured to track a pixel position being displayed.

20. The portable electronic device of claim 17, wherein the display has random access memory integrated therein.

21. The portable electronic device of claim 17, wherein the bit sequence is in RGB format and the intensity filter module is configured to receive all color components of the RGB format in a single clock cycle.

22. The portable electronic device of claim 17, wherein the display is one of a thin film transistor display or a liquid crystal display.

23. The portable electronic device of claim 17, wherein the display, the display controller, and the processor communicate over a bus.
